(19) United States
(12) Patent Application Publication
(10) Pub. No.: US 2024/0054509 A1
(43) Pub. Date: Feb. 15, 2024

(54) INTELLIGENT SHELFWARE PREDICTION AND SYSTEM ADOPTION ASSISTANT

(71) Applicant: SAP SE, Walldorf (DE)

(72) Inventors: Riju Mukhopadhyay, Walldorf (DE); Thorsten Henrichs, Karlsruhe (DE); Amit Lodhe, Bickenbach (DE); Sonali Jha, Heidelberg (DE); Ramkishan Mukesh Gupta, Singapore (SG)

(21) Appl. No.: 17/819,827

(22) Filed: Aug. 15, 2022

(51) Int. Cl. G06Q 30/02; G06Q 10/08

(52) U.S. Cl. CPC G06Q 30/0202; G06Q 10/087; G06Q 30/0201

(57) ABSTRACT

The present disclosure involves systems, software, and computer implemented methods for intelligent shelfware prediction and system adoption assistance. One example method includes identifying historical shelfware information for software products for customers of a software provider. The historical shelfware information is used to train machine learning models to generate a prediction that indicates a likelihood that a particular product for a particular customer will turn into shelfware. A request is received to generate a shelfware prediction for a first software product for a first customer of the software provider. A first trained machine learning model corresponding to the first software product and the first customer is identified. A first shelfware risk prediction is received from the first trained machine learning model that indicates a likelihood that the first software product turns into shelfware for the first customer. The first shelfware risk prediction is provided in response to the request.

### TECHNICAL FIELD

The present disclosure relates to computer-implemented methods, software, and systems for intelligent shelfware prediction and system adoption assistance.

### BACKGROUND

A software product may be referred to as “shelfware” if the software product was sold to a customer but then is never deployed or used by the customer. Shelfware may be purchased software that is not in active use, for example. For instance, a customer may have purchased a subscription to a cloud platform software product, but then never used any functionality of the cloud platform, never had any customer users log into the cloud platform, and never submitted a ticket or transaction related to the purchased product.

### SUMMARY

The present disclosure involves systems, software, and computer implemented methods for intelligent shelfware prediction and system adoption assistance. An example method includes: identifying historical shelfware information for software products for different customers of a software provider; using the historical shelfware information to train machine learning models, wherein each trained machine learning model is trained to generate a prediction that indicates a likelihood that a particular product for a particular customer will turn into shelfware; receiving a request to generate a shelfware prediction for a first software product for a first customer of the software provider; identifying a first trained machine learning model corresponding to the first software product and the first customer; receiving a first shelfware risk prediction from the first trained machine learning model that indicates a likelihood that the first software product turns into shelfware for the first customer; and providing the first shelfware risk prediction in response to the request.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for intelligent shelfware prediction and software adoption assistance.

FIG. 2 illustrates an example system for shelfware risk prediction.

FIG. 3 illustrates an example dashboard user interface.

FIG. 4 illustrates an example process for machine learning for intelligent shelfware prediction.

FIG. 5 illustrates an example system for automatic adoption assistance.

FIG. 6 is a flowchart of an example method for intelligent shelfware prediction.

### DETAILED DESCRIPTION

An intelligent shelfware prediction tool can predict a probability (e.g., shelfware risk) of a software product turning into shelfware in the future for a particular customer, based on a machine learning algorithm that analyzes historical usage data of software products stored in a repository. The intelligent shelfware prediction tool can also provide a breakdown of top contributing factors for a shelfware risk prediction to identify the root cause(s) for the shelfware risk prediction. The intelligent shelfware prediction tool can be part of an end-to-end process of shelfware containment and early adoption assistance for customers. The intelligent shelfware prediction tool can offer proactive prediction of shelfware risk for a product being positioned for sale within an opportunity or for a product recently sold. The intelligent shelfware prediction tool can provide a factual basis for assignment of valuable post-sales and other resources to customer accounts with high shelfware risk and also provide automated recommendations to multiple roles for implementation of use cases that can mitigate the risk of a product turning into shelfware. For example, the intelligent shelfware prediction tool can provide early insight into the risk of shelfware to several personas within an organization, which can allow the different personas to execute processes to mitigate the risk of shelfware, either in a sale phase or a post-sales phase such as prior to implementation. If shelfware risk information is generated and provided to post-sales teams, for products with high shelfware risk, timely implementation-planning actions can be planned, budgeted, and executed to help the customer improve adoption.

The solution described herein can provide various technical advantages. For example, increasing an adoption rate for a software product means resource use related to purchased software is more efficient, because a likelihood is reduced of wasting resources for distribution, installation, and deployment of software that does not get used. Rather, resolving cases of potential shelfware so as to avoid shelfware results in a higher resource utilization rate related to the software product.

Additionally, resource use for post-sales and other teams can be improved as compared to resource use that may occur without any type of shelfware prediction or determination. For instance, without shelfware prediction, products that have a high shelfware risk may be added to a bill of materials and sold to a customer without implementation of a plan to address or reduce the shelfware risk. Haphazard or shelfware-risk-agnostic deployment of post sales resources is generally inefficient, because resources may be spent on customers who don't particularly need much post-sales support. For instance, if a post-sales team is not aware of a high shelfware risk of a product, the post-sales team, which has limited resources, may expend those resources on other activities such as for products that have a lesser shelfware risk. Post-sales resources may be expended on products that are actually already on target for adoption, for example.

The proactive approach of the intelligent shelfware predictor also results in various technical advantages as compared to reactive shelfware determination. For example, with reactive shelfware detection, shelfware indicators may be detected after implementation but too close to renewal to allow time for mitigation procedures to be successful. Accordingly, resource use related to the installation, purchase, and deployment of the software, and resources used for any ultimately unsuccessful mitigation actions may be wasted. For instance, activities performed in response to reactive shelfware determination can consume limited resources of post-sales teams, and consumption of resources based on reactive shelfware determination may be expended on products that are too far along in turning into shelfware for performing successful mitigation actions. In general, with reactive approaches, shelfware may be detected too close to a renewal when an ability to influence adoption of the software is limited. For instance, a limited post-sales window (e.g., 180 days) may exist where mitigation actions are successful in preventing or counteracting shelfware situations.

Rather than use a reactive approach, a proactive determination of shelfware risk can enable a successful and efficient use of resources for mitigation actions during the post-sales window in which mitigation actions are likely to be successful. For example, early warnings or forecasts of shelfware risk can trigger proactive shelfware containment or reduction processes by sales and post-sales teams.

The proactive approach to shelfware prediction can cause post-sales resources to be assigned based on degree of shelfware risk rather than on other factors, such as size of customer, that might not reflect shelfware risk. For instance, with proactive shelfware prediction, products that have a high shelfware risk can be identified during a sales or pre-sales period so that a post-sales team can implement actions to address or reduce the shelfware risk. By having the proactive shelfware predictor provide post-sales roles with information on customers whose products are more likely to result in shelfware, the post-sales agent can separate those customers from the general population of customers to which the agent has been assigned, so that the agent can then trigger a very focused and highly tailored onboarding effort as part of a shelfware containment process for those customers. With the intelligent shelfware risk prediction solution, post-sales agents can proactively engage with customers to implement use cases as part of custom onboarding to increase software adoption. An adoption assistance engine can automatically identify such use cases.

Use of the adoption assistance engine can result in various technical advantages. For example, a post-sales user manually trying to find use cases for increasing adoption may result in more computing resources being used as compared to automatic adoption assistance, since trial and error searches and browsing of search results may result in many searches being sent to different repositories, different search results being generated and sent to client devices, and users spending a significant time on client devices browsing results. Additionally, a user may not know which use cases are best for increasing adoption. Accordingly, a use case may be deployed, which consumes resources, which may actually not increase adoption, and accordingly, software may still turn into shelfware (thus wasting resources consumed for the purchasing and distribution of that software). The user may not correctly identify use cases that can address contributing factors to shelfware risk. Use of the automated adoption assistance engine can increase likelihood of expending resources on implementing use cases that actually address specific contributing factors to shelfware risk.

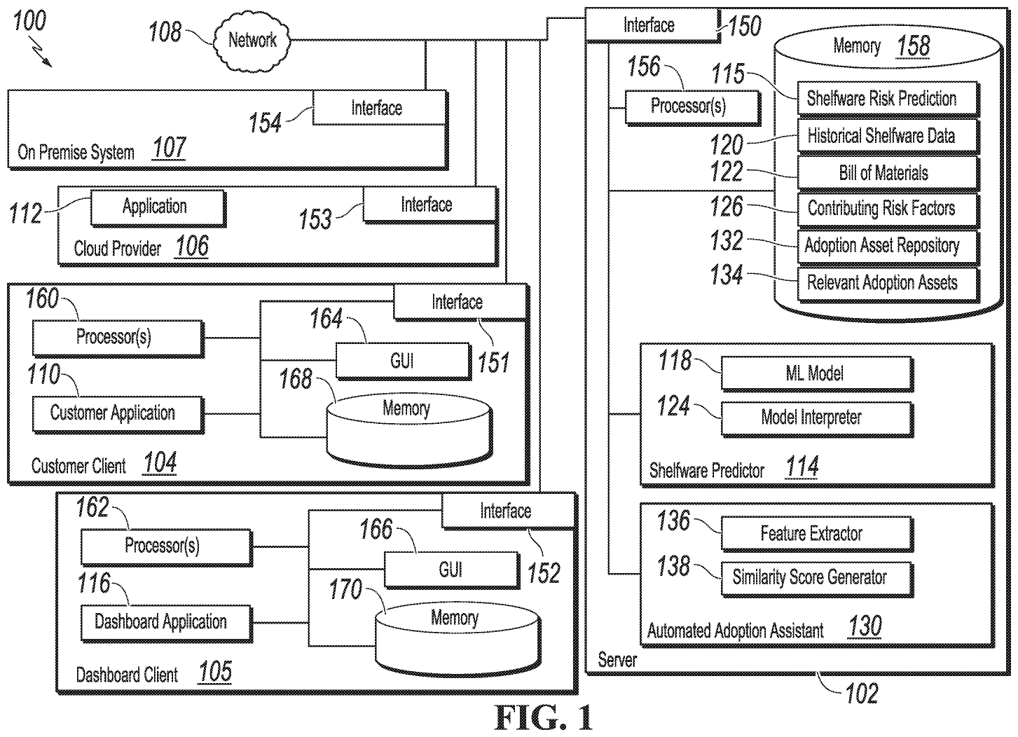

FIG. 1 is a block diagram illustrating an example system 100 for intelligent shelfware prediction and software adoption assistance. Specifically, the illustrated system 100 includes or is communicably coupled with a server 102, a customer client device 104, a dashboard client device 105, a cloud provider 106, an on-premise system 107, and a network 108. Although shown separately, in some implementations, functionality of two or more systems or servers may be provided by a single system or server. In some implementations, the functionality of one illustrated system, server, or component may be provided by multiple systems, servers, or components, respectively.

A software provider can provide software solutions to customers. For example, the software provider can provide solutions for execution in the on-premise system 107. As another example, the software provider can provide software to be used for services provided by the cloud provider 106. A customer can purchase a software product (or a license for a software product) that is offered by the software provider. A user of the customer can use, for example, a customer application 110 on the customer client device to access the software product. The customer application 110 can be a web-based application or a client-side version of a server or cloud-based application, such as an application 112.

As mentioned above, for some customers and some products, a purchased product may turn into shelfware. Rather than wait for a shelfware situation to occur, the software provider can configure and use a shelfware predictor 114 to intelligently and proactively predict shelfware risk for software products. The shelfware predictor 114 can generate a shelfware risk prediction 115 for any product offered by the software provider for any customer, to enable pro-active and earlier mitigation actions across the organization, as compared to existing reactive tools that track, rather than predict, adoption status. Shelfware risk predictions 115 can be displayed, for example, in a dashboard application 116, to various types of personnel associated with the software provider, such as sales, post-sales, management, and implementation personnel. Although the dashboard application 116 is described, generated shelfware risk predictions and automated adoption assistance information can be integrated into various types of user interfaces, such as CRM (Customer Relationship Management), customer success platform, sales, post-sales, management, implementation, adoption assistance, or other user interfaces.

The shelfware predictor 114 can include a ML (Machine Learning) model 118. The ML model 118 can be trained using historical shelfware data 120 corresponding to historical purchases of software products by customers and historical indications of active or inactive use (e.g., shelfware state) of the purchased products. After the ML model 118 is trained, the shelfware predictor 114 can use the ML model 118 to generate a shelfware risk prediction 115 for a recently-purchased or to-be-purchased software product.

For example, the shelfware risk predictor 114 can generate a shelfware risk prediction 115 for each product included in a bill of materials 122 for a customer. The bill of materials 122 can be obtained, for example, from an opportunity document or a sales order document, such as from a CRM system. A user of the dashboard client device 105 can, for example, select a bill of materials (or an opportunity or sales order document) using the dashboard application 116 and request a shelfware risk prediction. The dashboard client device 105 can send a request for a shelfware risk prediction to the server 102, and in response to receiving the request for the shelfware risk prediction, the shelfware predictor 114 can use the ML model 118 to generate the shelfware risk prediction 115 and provide the shelfware risk prediction 115 to the dashboard client device 105, for presentation in the dashboard application 116.

In addition to the shelfware risk prediction 115, the shelfware predictor 114 can use a model interpreter 124 to determine contributing risk factors 126 that can include, for example, factors that contributed to a highest degree (among other factors) to the generated shelfware risk prediction 115. The server 102 can provide the contributing risk factors 126 to the dashboard client device 105, for presentation in the dashboard application 116, along with the shelfware risk prediction 115.

Additionally, in some implementations, an automated adoption assistant 130 can automatically identify, from an adoption asset repository 132 (or multiple adoption asset repositories), relevant adoption assets 134 that are relevant for addressing the contributing risk factors 126 or the shelfware risk prediction 115 in general. For example, a feature extractor 136 can automatically identify a first set of features associated with the contributing risk factors 126 and/or with the product for which the shelfware risk prediction 115 was generated. The feature extractor 136 can then automatically identify, for each asset in the adoption asset repository 132, a second set of features for the adoption asset. The automated adoption assistant 130 can use a similarity score generator 138 to generate a similarity score for each adoption asset that indicates a degree of match between the adoption asset and the first set of features associated with the contributing risk factors 126 and the product. The automated adoption assistant 130 can identify the relevant adoption assets 134 as being adoption assets that have the highest similarity scores. Information for the relevant adoption assets 134 can be provided to the dashboard client device 105, for presentation in the dashboard user interface 116.

Use of the automated adoption assistant 130 can eliminate a manual effort required to locate relevant adoption assets from thousands of adoption assets that may be present, for example, in multiple repositories, thus valuable time and computing resources. The shelfware predictor 114 and the automated adoption assistant 130 can be used as part of a shelfware containment process that provides an intelligent, automated approach for identification, analysis, and mitigation of shelfware risk. Further details of the automated adoption assistant 130 and the shelfware risk predictor 114 (particularly the ML model 118) are described below.

As used in the present disclosure, the term “computer” is intended to encompass any suitable processing device. For example, although FIG. 1 illustrates a single server 102, a single customer client device 104, a single dashboard client device 105, a single cloud provider 106, and a single on-premise system 107, the system 100 can be multiples of such devices. Additionally, the server 102 and the dashboard client device 105, for example, may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server 102 and the dashboard client device 105 may be adapted to execute any operating system, including Linux, UNIX, Windows, Mac OS®, Java™, Android™, iOS or any other suitable operating system. According to one implementation, the server 102 may also include or be communicably coupled with an e-mail server, a Web server, a caching server, a streaming data server, and/or other suitable server.

Interfaces 150, 151, 152, 153, and 154 are used by the server 102, the customer client device 104, the dashboard client device 105, the cloud provider 106, and the on-premise system 107, respectively, for communicating with other systems in a distributed environment—including within the system 100—connected to the network 108. Generally, the interfaces 150, 151, 152, 153, and 154 each comprise logic encoded in software and/or hardware in a suitable combination and operable to communicate with the network 108. More specifically, the interfaces 150, 151, 152, 153, and 154 may each comprise software supporting one or more communication protocols associated with communications such that the network 108 or interface's hardware is operable to communicate physical signals within and outside of the illustrated system 100.

The server 102 includes one or more processors 156. Each processor 156 may be a central processing unit (CPU), a blade, an application specific integrated circuit (ASIC), a field-programmable gate array (FPGA), or another suitable component. Generally, each processor 156 executes instructions and manipulates data to perform the operations of the server 102. Specifically, each processor 156 executes the functionality required to receive and respond to requests from the client device 104, for example.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Visual Basic, assembler, Peri®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The server 102 includes memory 158. In some implementations, the server 102 includes multiple memories. The memory 158 may include any type of memory or database module and may take the form of volatile and/or non-volatile memory including, without limitation, magnetic media, optical media, random access memory (RAM), read-only memory (ROM), removable media, or any other suitable local or remote memory component. The memory 158 may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the server 102.

The customer client device 104 and the dashboard client device 105 may each generally be any computing device operable to connect to or communicate with other devices via the network 108 using a wireline or wireless connection. The customer client device 104 and the dashboard client device 105 can each include one or more client applications, including the client application 110 or the dashboard application 116, respectively. In general, a client application is any type of application that allows the customer client device 104 or the dashboard client device 105 to request and view content on the respective device. In some implementations, a client application can use parameters, metadata, and other information received at launch to access a particular set of data from the cloud platform 106 or the server 102. In some instances, a client application may be an agent or client-side version of the one or more enterprise applications running on an enterprise server (not shown).

The customer client device 104 and the dashboard client device 105 includes processor(s) 160 or processor(s) 162, respectively. Each processor included in the processor(s) 160 or processor(s) 162 may be a central processing unit (CPU), an application specific integrated circuit (ASIC), a field-programmable gate array (FPGA), or another suitable component. Generally, each processor included in the processor(s) 160 or processor(s) 162 executes instructions and manipulates data to perform the operations of the customer client device 104 or the dashboard client device 105, respectively. Specifically, each processor included in the processor(s) 160 or processor(s) 162 executes the functionality required to send requests to the server device or system (e.g., the server 102 or the cloud platform 106) and to receive and process responses from the server device or system.

Each of the customer client device 104 and the dashboard client device 105 are generally intended to encompass any client computing device such as a laptop/notebook computer, wireless data port, smart phone, personal data assistant (PDA), tablet computing device, one or more processors within these devices, or any other suitable processing device. For example, the customer client device 104 and/or the dashboard client device 105 may comprise a computer that includes an input device, such as a keypad, touch screen, or other device that can accept user information, and an output device that conveys information associated with the operation of the server 102, or the respective client device itself, including digital data, visual information, or a GUI (Graphical User Interface) 164 or GUI 166, respectively.

The GUI 164 and the GUI 166 can each interface with at least a portion of the system 100 for any suitable purpose, including generating a visual representation of the customer application 110 or the dashboard application 116, respectively. In particular, the GUI 164 and the GUI 166 may each be used to view and navigate various Web pages, or other user interfaces. Generally, the GUI 164 and the GUI 166 each provide the user with an efficient and user-friendly presentation of business data provided by or communicated within the system. The GUI 164 and the GUI 166 may each comprise a plurality of customizable frames or views having interactive fields, pull-down lists, and buttons operated by the user. The GUI 164 and the GUI 166 each contemplate any suitable graphical user interface, such as a combination of a generic web browser, intelligent engine, and command line interface (CLI) that processes information and efficiently presents the results to the user visually.

Memory 168 or memory 170 included in the customer client device 104 or the dashboard client device 105 may each include any memory or database module and may take the form of volatile or non-volatile memory including, without limitation, magnetic media, optical media, random access memory (RAM), read-only memory (ROM), removable media, or any other suitable local or remote memory component. The memory 168 and the memory 170 may each store various objects or data, including user selections, caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the customer client device 104 or the dashboard client device 105.

There may be any number of customer client devices 104 and dashboard client device 105 associated with, or external to, the system 100. For example, while the illustrated system 100 includes one customer client device 104 and one dashboard client device 105, alternative implementations of the system 100 may include multiple customer client devices 104 and/or multiple dashboard client devices 105 communicably coupled to the server 102 and/or the network 108, or any other number suitable to the purposes of the system 100. Additionally, there may also be one or more additional customer client devices 104 and/or dashboard client devices 105 external to the illustrated portion of system 100 that are capable of interacting with the system 100 via the network 108. Further, the term “client”, “client device” and “user” may be used interchangeably as appropriate without departing from the scope of this disclosure. Moreover, while the customer client device 104 or the dashboard client device 105 may be described in terms of being used by a single user, this disclosure contemplates that many users may use one computer, or that one user may use multiple computers.

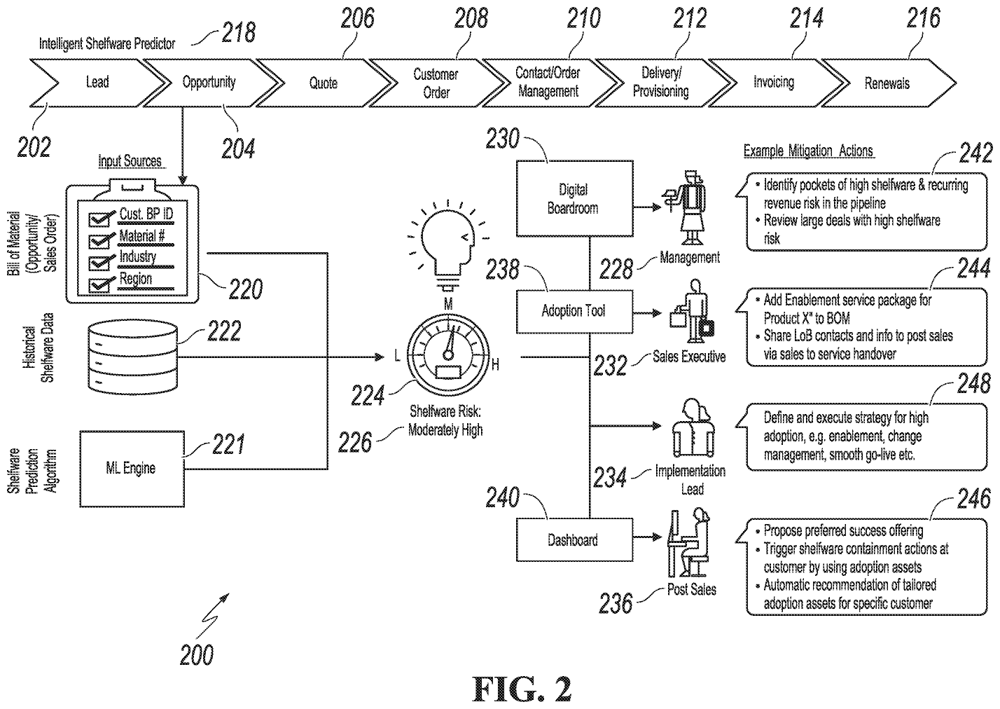

FIG. 2 illustrates an example system 200 for shelfware risk prediction. A software product can undergo various lifecycle stages with respect to a purchasing of the software product by a customer. For example, a sale of a software product to a customer can involve lead 202, opportunity 204, quote 206, customer order 208, contract/order management 210, delivery/provisioning 212, invoicing 214, and renewals 216 stages. As described above, if an entity determines that a software product may be or is turning into shelfware too close to the renewals stage 216, the determination may occur too close to a renewal deadline to allow time to prevent the product from turning into shelfware. Rather than wait until later in the lifecycle of the software product to realize the software product may be turning into shelfware, an intelligent shelfware predictor 218 be used in earlier lifecycle stages of the software product to enable successful mitigation of a shelfware situation. For example, the intelligent shelfware predictor 218 can generate a shelfware prediction early in an overall process of selling a software product to a customer, such as in the opportunity stage 204 or customer order stage 208.

For example, when an opportunity is created for a customer for one or more software products, a bill of material 220 can be provided as an input to a ML engine 221. The bill of materials 220 can specify, for a given customer, which products are targeted for sale (or have been sold) to the customer, as well as other customer information, such as an industry, region, or other attributes of the customer. The ML engine 221 can use a trained ML model previously trained using historical shelfware data 222, for example. The historical shelfware data 222 can be a repository that includes information that indicates which products a given customer previously purchased, which products were ultimately utilized, and which products turned into shelfware. Shelfware indications in the historical shelfware data 222 can be based on a lack of signs of life for a software product. For example, signs of life can include user logins, user use of certain features of the software product, etc.

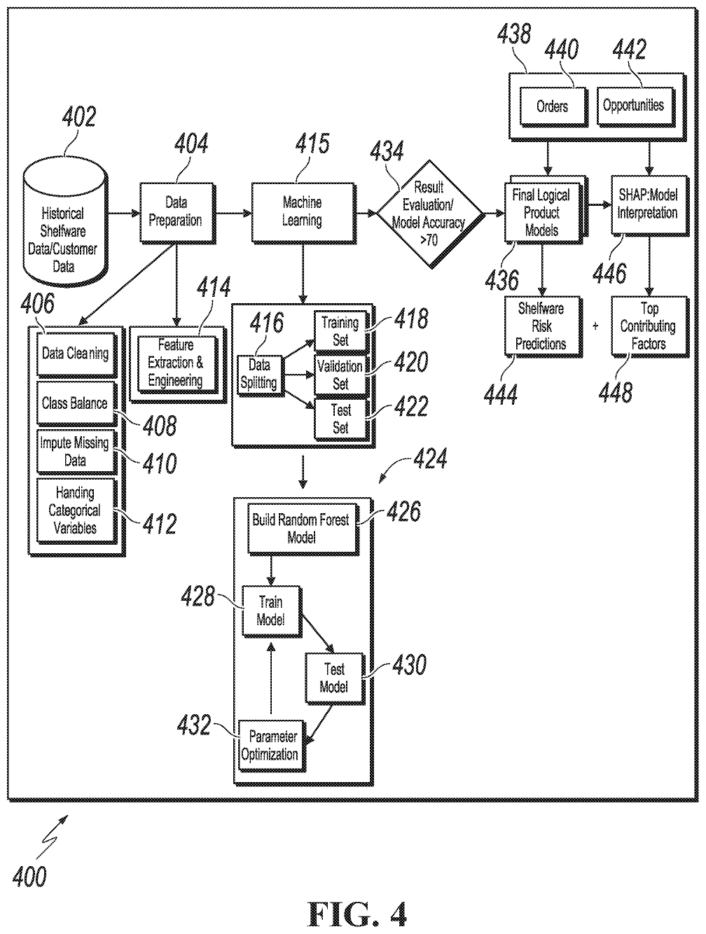

The ML engine 221 can generate, for each software product in the bill of materials, a shelfware risk prediction 224. The shelfware risk prediction 224 can be, for example, a probability value that indicates a likelihood that a given software product will turn into shelfware. In some implementations, a probability can be mapped to a category or tier of risk, such as low, medium, moderately-high 226, high, very-high, etc. For example, probability values in ranges of 0%-10%, 10%-15%, 15%-20%, 20%-25%, 30%-35%, and 40%-100% may be mapped to tiers of low, medium, moderately-high, high, and very-high. The ML engine 221 is described in more detail below with respect to FIG. 4.

Generated shelfware risk predictions can be provided to various roles in different types of user interfaces. For example, management 228 can view shelfware risk predictions in a digital boardroom application 230. As another example, a sales executive 232, an implementation lead 234, and/or a post-sales role 236 can view shelfware risk predictions in an adoption tool 238 and/or in another type of dashboard 240. Each role that receives a shelfware risk prediction can perform one or more mitigation actions to prevent or reduce a risk of a product turning into shelfware.

For example, as indicated in a note 242, a manager can use the digital boardroom application 230 to identify pockets of high shelfware risk and corresponding recurring-revenue risk in an upcoming revenue pipeline. The manager can review, and take action on, large deals that have a high shelfware risk. In general, management 228 can use shelfware risk predictions to spot risky deals early and take preventative action to minimize revenue risk in a revenue pipeline. In the digital boardroom application 230 (or other application), management 228 can view of estimates of upcoming revenue. The estimates of upcoming revenue can be adjusted (and/or qualified) with a potential revenue loss that can be determined based on a predicted shelfware risk. For example, predicted upcoming recurring revenue can be decreased for a product based on a tier (e.g., low, medium, high) of shelfware risk. Management 228 can take preventative measures (e.g., assigning more resources to a team that is servicing product adoption for a customer) and/or accept adjusted forecasts that have been adjusted based on shelfware risk. Management 228 can use the digital boardroom application 230, to determine, for example, for a product or product category, which customers have highest shelfware risk, and then proactively assign resources to those customers based on a degree of shelfware risk.

As another example and as indicated in a note 244, the sales executive 232 can, based on viewing a particular shelfware risk prediction in the adoption tool 238, add an enhancement service package for a product to a bill of materials, which can result in more service resources being assigned to the customer for the product. As another example, the sales executive can share information (e.g., a viewed shelfware risk prediction, line of business contacts, or other information) to the post-sales role 236 as part of a sales-to-service handover process, to make the post-sales role 236 aware of the shelfware risk during the handover and to provide any information that the post-sales role 236 may find useful for mitigating the shelfware risk. In general, the sales executive 232 can be presented with a predicted shelfware risk during opportunity creation and deal execution. If a product in a bill of materials has a shelfware risk in particular tiers (e.g., moderately-high, high, very-high), the sales executive 232 can create an adoption plan with a post-sales team during the sales handover stage so that the post-sales team can execute the adoption plan in a timely manner so as to prevent or reduce occurrences of shelfware.

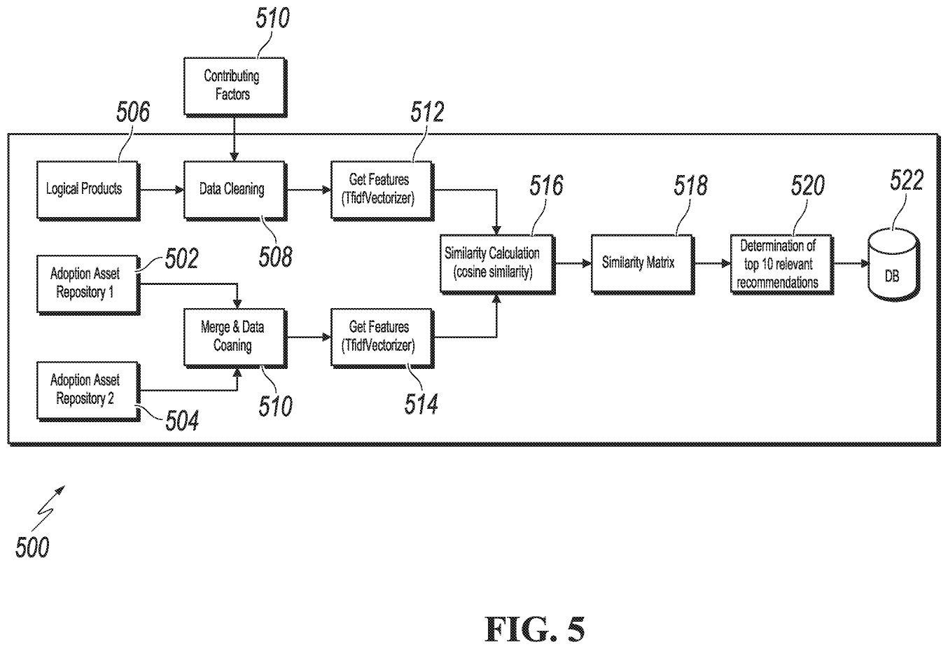

In further detail and as indicated in a note 246, the post-sales role 236 can, in response to being informed of or viewing a predicted shelfware risk for a product, propose a preferred success offering to the customer that can include deployment of additional resources that may improve customer adoption of the product. The post-sales role 236 can trigger (or can be informed of automatic triggering of) shelfware containment actions that use deployed adoption assets. The post-sales role 236 can receive recommendations for use of adoption assets that have been automatically identified based on contributing risk factors that contribute to a shelfware risk prediction for a product. As indicated by a note 248, the implementation lead 234 can, based on a given shelfware risk prediction, define and execute a strategy for improved adoption for products that have a high shelfware risk. Automatic adoption assistance is described in more detail below with respect to FIG. 5.

In general, for the implementations lead 234 and the post-sales role 236, adoption planning can start proactively right after sales completion, and adoption can be improved based on an improved and informed handover from the sales executive 232. A certain time period after a sale, such as a first 180 days, may provide a window of opportunity for an entity to overcome a potential shelfware situation at a customer. Shelfware risk predictions generated by the intelligent shelfware predictor 218 can enable tailored onboarding of a customer, immediately after a sale and during this window of opportunity. Automatic shelfware risk generation can be used to separate shelfware-risk customers from a general population of customers, to enable focused and efficient onboarding efforts with prioritized resource allocation.

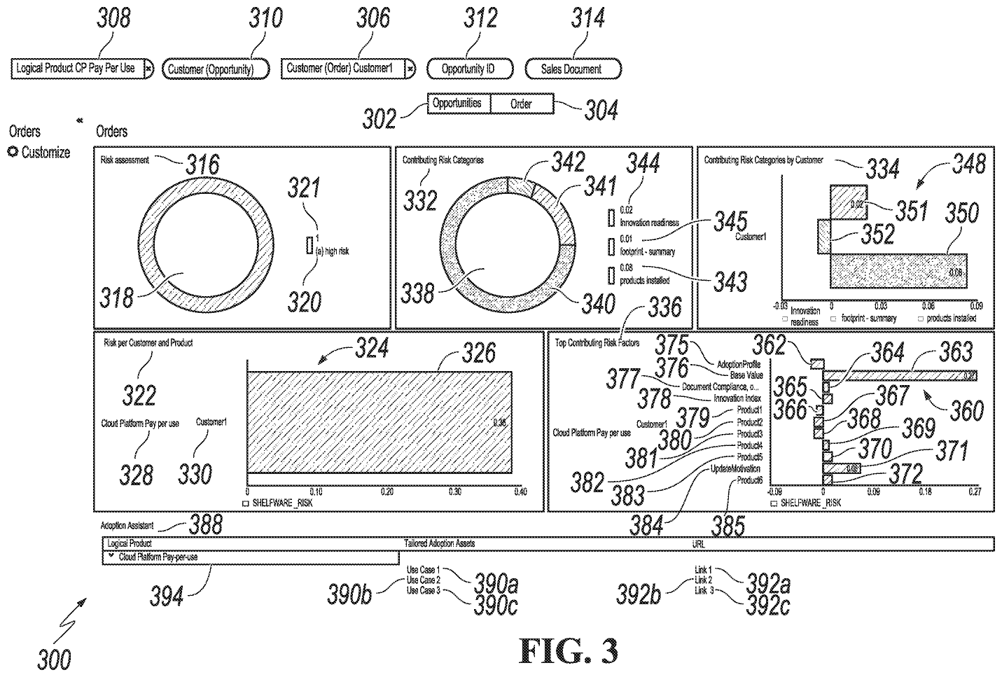

FIG. 3 illustrates an example dashboard user interface 300. The dashboard user interface 300 can be presented to various pre- and post-sales roles, for example. The dashboard user interface 300 can be used to display shelfware risk predictions for logical products for selected customer(s). Logical products can be products or product components that are included in a bill of materials (e.g., a logical product can be either a purchased product or an identifiable component of a purchased product for which a shelfware risk can be determined). The dashboard user interface 300 can be used to display shelfware risk predictions based on logical products included in or otherwise associated with a bill of materials for an opportunity or a sales order, for example. For instance, the user can toggle between an opportunity view or a sales order persona using an opportunities toggle button 302 or a sales order toggle button 304, respectively.

Currently, the sales order toggle button 304 is selected, resulting in the dashboard user interface 300 displaying information about logical products in sales order(s) for a particular customer that is selected using a customer filter 306. For example, the customer filter 306 corresponds to selection of a “Customer1” customer. A logical product filter 308 can be used to filter logical products for the customer by a particular logical product type. For example, the logical product filter 308 corresponds to selection of a cloud platform (CP) pay-per-use logical product. Other filters can include a customer filter 310, an opportunity ID filter 312 and a sales document filter 314.

The dashboard user interface 300 includes a risk assessment area 316 that includes predicted shelfware risk value(s) for selected logical product(s) and a selected customer. The predicted shelfware risk value(s) can be generated by a trained machine learning model, as described above (and as described in more detail below). The risk assessment area 316 includes a circle chart 318 that includes a colored segment for each logical product for which a shelfware risk has been generated. In the displayed example, the circle chart 318 includes one segment, but if multiple shelfware risk predictions are generated (such as for all or multiple products included in a bill of materials), the circle chart 318 can include multiple segments (e.g., where each segment may have a different color). A color (or other type of style) of a segment in the circle chart 318 can correspond to a shelfware risk tier or category, such as low risk, medium risk, high risk, etc., as described above. In the displayed example, the one segment of the circle chart 318 is shown in a color that corresponds to a high risk tier, as indicated by a legend 320. For each risk tier that is shown in the circle chart 318, a count can be shown that indicates how many predictions are shown for that risk tier. For example, a count 321 of one indicates that the circle chart 318 is displaying one high risk prediction.

The dashboard user interface 300 also includes a risk per customer and product area 322. The risk per customer and product area 322 can include a bar chart 324 that includes a bar for each logical product and customer combination for which a shelfware risk prediction was generated. For instance, the bar chart 324 includes a bar 326 that represents a shelfware risk for a cloud platform pay-per-use product 328 and a Customer1 customer 330. The bar 326 can be displayed in a color (or other type of style) that corresponds to a category or tier of shelfware risk, using, for example, a same styling scheme as used for the color chart 318. The length of the bar 326 can correspond to a degree of shelfware risk (e.g., with a longer bar representing a greater amount of shelfware risk).

In addition to a shelfware risk prediction for a logical product for a customer, contributing risk factors can be calculated for the shelfware risk prediction, as described above, and contributing risk factor information can be displayed in the dashboard user interface 300. For example, a contributing risk categories area 332, a contributing risk categories by product area 334, and a top contributing risk factors area 336 are displayed. Information in the contributing risk categories area 332, the contributing risk categories by product area 334, and the top contributing risk factors area 336 can correspond to a selected shelfware risk prediction (e.g., a user selection of a particular segment in the circle chart 318 or a particular bar in the bar chart 324).

The contributing risk categories area 332 includes a circle chart 338 that includes different segments, where each segment corresponds to a particular category of factors that contributed to a particular (e.g., selected) shelfware risk prediction. For example, the circle chart 338 includes segments 340, 341, and 342 that correspond to products-installed, innovation readiness, and footprint-summary categories, respectively. The footprint-summary category represents an entire portfolio of live and shelfware products for a customer. The products-installed category represents an inter-relationship between different products in a customer's portfolio and how the inter-relationship(s) affect shelfware risk. For example, machine learning algorithms may determine a pattern in that every time (or a substantial percentage of occurrences) where product B is purchased without first installing product A, product B becomes shelfware (e.g., due to a dependence of product B on product A for product B to be used effectively). With the circle chart 338, a relative length of a respective segment corresponds to a degree of contribution to the particular shelfware risk prediction, with a longer segment indicating a higher contribution. For example, the segments 340, 341, and 342 are shown in decreasing segment size, corresponding to contribution amounts 343, 344, and 345 of 0.08, 0.02, and 0.01 for the products-installed, innovation readiness, and footprint-summary categories, respectively.

The contributing risk categories by product area 334 can display similar information to that shown in the contributing risk categories area 332, except in bar chart form. For example, the contributing risk categories by product area 334 includes a bar chart 348 that includes bars 350, 351, and 352 that correspond to the segments 340, 341, and 342, respectively. Values for a contributing risk category can affect a shelfware risk prediction for a logical product for a customer by either increasing or decreasing an amount of shelfware risk. For example, the bars 340 and 351 being shown as positive-value bars indicate that values for the products-installed and innovation-readiness categories for a logical product for a customer both increase an amount of shelfware risk (e.g., by values 0.08 and 0.02, respectively). In contrast, the bar 352 being shown as a negative-value bar indicates that a value for the footprint-summary category decreases an amount of shelfware risk for the logical product for the customer.

The top contributing risk factors area 336 provides more specific information about contributions of specific risk factors (e.g., as compared to aggregate contributing risk category information shown in the contributing risk categories area 332 and the contributing risk categories by product area 334). For example, the top contributing risk factors area 336 includes a bar chart 360 that includes bars 362, 363, 364, 365, 366, 367, 368, 369, 370, 371, and 372 corresponding to contributing risk factors 375, 376, 377, 378, 379, 380, 381, 382, 383, 384, and 385, respectively. The risk factor 376 represents a baseline value that indicates a calculated shelfware prediction risk for the logical product as a standalone risk calculation generated without considering other factors. The other risk factors other than the risk factor 376 can add to or reduce the baseline shelfware risk. For example, as shown in the bar chart 360, some bars (e.g., the bar 363 and the bar 371) are positive-value bars and other bars (e.g., the bar 362 and the bar 367) are negative-value bars. Some of the displayed risk factors correspond to installed products (e.g., Product1, Product2, etc.). Other risk factors can be of another type of risk factor. For example, the risk factor 384 corresponds to update motivation, which can correspond to an index that is calculated from different metrics that reflect a motivation for a customer to upgrade products. As another example, the risk factor 378 corresponds to an innovation index, which is in an index that can be calculated from different metrics and which indicates a degree to which a customer has been purchasing new releases of products.

The dashboard user interface 300 (or another user interface) can include an adoption assistant area 388 that includes information about adoption assets that have been automatically identified as best assets for addressing a respective contribution for at least some of the contributing risk factors shown in the top contributing risk factors area 336. For example, the adoption assistant area includes use cases 390a, 390b, and 390c (and corresponding respective links 392a, 392b, and 392c) for a logical product 394. If multiple logical products have been selected, a set of adoption assets for each logical product may be displayed in the adoption assistant area. Adoption assets can be developed use cases, white papers, or other types of resources. An adoption asset for a logical product may be identified that, if utilized, may decrease a positive contribution of a given factor to a shelfware risk for logical product for the customer or increase a negative contribution of a given factor to the shelfware risk. More details regarding automatic identification of adoption assets are provided below.

FIG. 4 illustrates an example process 400 for machine learning for intelligent shelfware prediction. Customer information and historical shelfware data can be retrieved from a repository 402 and provided to a data preparation engine 404. The data preparation engine 404 can perform data cleaning operations 406, class balancing operations 408, missing data imputing operations 410, and categorical variable handling operations 412. The data cleaning operations 406 can include handling of missing data values, removing duplicate values, or adjusting data to handle structural errors.

The class balancing operations 408 be performed to handled dataset imbalances that may occur in the received historical shelfware data, for example. For example, oversampling can be performed for minority classes in the historical shelfware data. For example, minority class samples can be duplicated (e.g., new samples can be synthesized from existing samples, such as by using a Synthetic Minority Oversampling Technique (SMOTE). In some cases, the missing data imputing operations 410 can be performed for minority and/or majority classes. The missing data imputing operations 410 can include generating estimated values from existing information, for example.

The categorical variable handling operations 412 can include converting categorical data to numerical values. For example, non-numerical values can be converted to numerical values using a one-hot encoding technique.

Feature extraction and engineering 414 can be performed to generate machine learning features for a machine learning model 415. Features can include, for example, different “firmographics” features that correspond to a customer type. Customer types can describe a customer size, a customer industry sector, etc. Other features can correspond to different metrics that reflect an innovation readiness of the customer. For example, an innovation index can be calculated that indicates general and/or early participation with different technology suites offered by the service provider. An update motivation metric can be calculated that indicates a customer motivation to upgrade existing products to current releases (e.g., based on historical upgrade history). An adoption profile can indicate a customer motivation to adopt new service provider products. An adoption profile can indicate a customer motivation to adopt new service provider products. An adoption profile index can be calculated that represents an overall adoption status and the adoption profile of the customer. The adoption profile index can be based on a newness of the customer and a number of adopted products used by the customer. For example, an adoption profile index of ten can be calculated for either new customers who have more than ten products or older, high adopter customers who have more than thirty products in productive use. A lower adoption index can be calculated if a newer or older customer has fewer adopted products, for example. Other features can reflect customer adoption of different categories of products (e.g., cloud offerings, enterprise suite) or other types of customer motivation or engagement. Additionally, different features can represent a customer's overall footprint of historical product purchases, whether those products are live, whether those products have turned into shelfware, etc.

A determination can be made as to whether sufficient historical information exists for building a model for a given customer and logical product. If there is not sufficient historical information, a determination can be made to not build a model for the logical product for the customer. If sufficient historical information exists, a data splitting process 416 can be performed to split prepared data for given customer into a training set 418, a validation set 420, and a test set 422. For example, as shown for a model building process 424 that can be used to build a model 426 for a logical product for a customer, the training set 418 can be used to train the model 426 in a training phase 428, the test set 422 can be used to test the model 426 in a testing phase 430, and the validation set 420 can be used to optimize model parameters in a parameter optimization phase 432 (e.g., using hyperparameter tuning, such as using a grid search approach). The model 426 can be a random forest classifier model, for example.

A model accuracy can be calculated for each run of the testing phase 430 for the model 426. Training, testing, and parameter optimization can be iteratively performed, for example, until an optimized parameter set produces a best accuracy. Models for which an accuracy test 434 results in at least a threshold accuracy (e.g., 70% accuracy) can be included in a set of final logical product models 436 (e.g., where each model in the set of final logical product models 426 is trained to predict shelfware for a given logical product for a given customer).

In an inference phase, bill of material information 438 (which can relate, for example, to orders 440 or opportunities 442 information) corresponding to a given logical product for a given customer can be provided to the corresponding trained machine learning model in the set of final logical product models 426. The corresponding trained machine learning model can generate a shelfware risk prediction 444 for the given logical product for the customer. The shelfware risk prediction 444 can be provided to various personnel or systems, in various ways, as described above.

Additionally, a SHAP (SHapely Additive Explanation) model interpretation component 446 can be used to generate top contributing risk factors 448 for a given shelfware risk prediction 444. The SHAP model interpretation component 446 uses Shapely values to measure feature contribution to a machine learning output. The top contributing risk factors 448 can be provided along with the shelfware risk prediction 444 to illustrate underlying reasons of why a model assigned a certain risk assessment. Providing the top contributing risk factors 448 can improve transparency for ML determinations, which can increase trust, clarity, and understanding of outputs of the ML process by turning use of the ML process into an “explainable AI (Artificial Intelligence)” experience” for users of the intelligent shelfware prediction.

FIG. 5 illustrates an example system 500 for automatic adoption assistance. The system 500 can be used to automatically identify tailored adoption assets that can be used to mitigate the risk of shelfware by increasing a likelihood that a customer will adopt a software product. Adoption assets can include line of business use cases, industry use cases, other use cases, white papers, and other types of resources. An entity may have, for example, thousands of potential adoption assets, such as in a first adoption asset repository 502, a second adoption asset repository 504, and possibly other repositories. A post-sales or other role, for example, may miss important relevant assets if trying to find assets manually (and may spend a substantial amount of time trying to manually search the adoption asset repositories). Automatic adoption asset identification, in contrast, can more accurately (and more quickly) find relevant adoption assets.

For a given logical product included in logical products 506 in a bill of materials for a customer for which a shelfware risk prediction has been generated, logical product information (e.g., description, metadata) of the logical product can be provided as input to a data cleaning process 508. Additionally, the data cleaning process 508 can receive contributing factor information from contributing factors 510 that have been identified as contributing to a shelfware risk prediction for the logical product. The data cleaning process 508 can be used to clean received logical product and contributing factor information. For example, the data cleaning process 508 can include removal of stop words from logical product and contributing factor information.

In a similar fashion, a merge and data cleaning process 510 can be performed on information retrieved from the first adoption asset repository 502 and the second adoption asset repository 504. Merging can include identification and removal of adoption asset information that is redundant among two or more adoption asset repositories, for example. Data cleaning, which can include similar stop word removal as the data cleaning process 508, can be performed on the merged adoption asset information.

A feature identification process 512 can be performed on cleaned logical product and contributing factor information. Similarly, a feature identification process 514 can be performed on cleaned adoption asset information. The feature identification process 512 and the feature identification process 514 can each include TF-IDF (Term Frequency-Inverse Document Frequency) vectorization of cleaned logical product and contributing factor information or cleaned adoption asset information, respectively. TD-IDF vectorization can include identification of words that are most significant in a collection. An output of the feature identification process 512 can be a vector of the most relevant and important words in cleaned logical product information and cleaned contributing factor information. An output of the feature identification process 514 can include, for each respective adoption asset, a vector of the most important words in the cleaned adoption asset information for that adoption asset.

A similarity calculation 516 can be performed to compare, for each adoption asset, the feature vector output of the feature identification process 514 for the adoption asset to the feature vector output of the feature identification process 512. For example, the similarity calculation 516 can include calculation of a cosine similarity value that measures a similarity between the feature vector for an adoption asset and a feature vector generated by the feature identification process 512. Calculated cosine similarity values can be stored in a similarity matrix 518.

Atop-match determination 520 can be performed to determine a top number (e.g., ten) of matching adoption assets with highest similarity scores in the similarity matrix 518 as recommended adoption assets for mitigation of shelfware risk for a logical product. Information identifying the top matching adoption assets can be stored in a database 522 and/or presented to various roles (sales, post-sales, management, implementation leads), as described above.

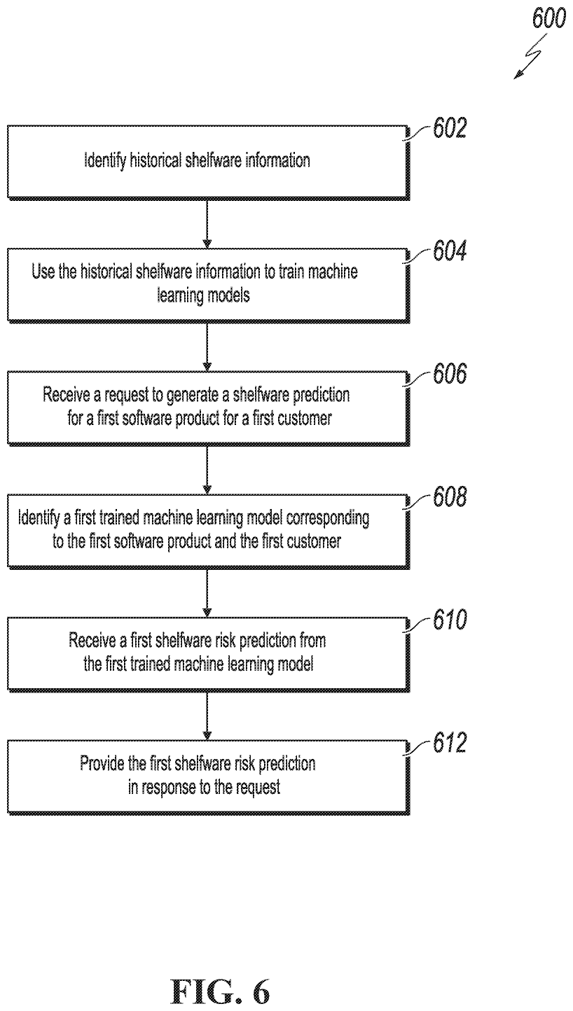

FIG. 6 is a flowchart of an example method for intelligent shelfware prediction. It will be understood that method 600 and related methods may be performed, for example, by any suitable system, environment, software, and hardware, or a combination of systems, environments, software, and hardware, as appropriate. For example, one or more of a client, a server, or other computing device can be used to execute method 600 and related methods and obtain any data from the memory of a client, the server, or the other computing device. In some implementations, the method 600 and related methods are executed by one or more components of the system 100 described above with respect to FIG. 1. For example, the method 600 and related methods can be executed by the server 102 of FIG. 1.

At 602, historical shelfware information for software products for different customers of a software provider is identified. A software product can turn into shelfware if the software product is not used after being purchased. The historical shelfware information can indicate whether software products purchased from the software provider turned into shelfware, based on signs of life, such as product feature use, product logins, etc.

At 604, the historical shelfware information is used to train machine learning models. Each trained machine learning model can be trained to generate a prediction that indicates a likelihood that a particular product for a particular customer will turn into shelfware.

At 606, a request is received to generate a shelfware prediction for a first software product for a first customer of the software provider. The first software product can be referenced in a bill of materials that may be associated with a sales order or an opportunity document. The first software product can be a logical software product that is an identifiable component of a software product offered for sale.

At 608, a first trained machine learning model corresponding to the first software product and the first customer is identified. The first trained machine learning model can be a random forest model.

At 610, a first shelfware risk prediction is received from the first trained machine learning model that indicates a likelihood that the first software product turns into shelfware for the first customer.

At 612, the first shelfware risk prediction is provided in response to the request. The first shelfware risk prediction can be provided to one or more of sales, post-sales, or management personnel of the software provider. As another example, the first shelfware risk prediction can be provided to an automated system that can automatically identify one or more shelfware containment actions to perform in response to the first shelfware risk prediction being more than a threshold.

In some implementations, a model interpretation process for the first trained machine learning model and the first shelfware risk prediction can be performed to determine a set of one or more top contributing risk factors that most contributed to the first shelfware risk prediction. The set of one or more top contributing risk factors can be provided in response to the request, along with the shelfware risk prediction. In some implementations, a set of one or more adoption assets that most closely match a top contributing risk factor can be automatically identified. Information for the automatically identified set of one or more adoption assets can be provided in response to the request, such as with the shelfware risk prediction and/or the top contributing risk factors.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method comprising:
identifying historical shelfware information for software products for different customers of a software provider;
using the historical shelfware information to train machine learning models, wherein each trained machine learning model is trained to generate a prediction that indicates a likelihood that a particular product for a particular customer will turn into shelfware;
receiving a request to generate a shelfware prediction for a first software product for a first customer of the software provider;
identifying a first trained machine learning model corresponding to the first software product and the first customer;
receiving a first shelfware risk prediction from the first trained machine learning model that indicates a likelihood that the first software product turns into shelfware for the first customer; and
providing the first shelfware risk prediction in response to the request.

2. The computer-implemented method of claim 1, wherein the historical shelfware information indicates whether software products purchased from the software provider turned into shelfware.

3. The computer-implemented method of claim 2, wherein a software product turns into shelfware if the software product is not used after being purchased.

4. The computer-implemented method of claim 1, wherein the first trained machine learning model is a random forest model.

5. The computer-implemented method of claim 1, wherein receiving the request comprises identifying the first software product in a bill of materials for the first customer.

6. The computer-implemented method of claim 5, wherein the bill of materials is associated with a sales order for the first customer.

7. The computer-implemented method of claim 5, wherein the bill of materials is associated with an opportunity document for the first customer.

8. The computer-implemented method of claim 1, wherein the first software product is an identifiable component of a second software product.

9. The computer-implemented method of claim 1, wherein the first shelfware risk prediction is provided to sales, post-sales, or management personnel of the software provider.

10. The computer-implemented method of claim 1, wherein the first shelfware risk prediction is provided to an automated system that automatically identifies one or more shelfware containment actions to perform in response to the first shelfware risk prediction being more than a threshold.

11. The computer-implemented method of claim 1, further comprising:
performing a model interpretation process for the first trained machine learning model and the first shelfware risk prediction to determine a set of one or more top contributing risk factors that most contributed to the first shelfware risk prediction; and
providing the set of one or more top contributing risk factors in response to the request.

12. The computer-implemented method of claim 11, further comprising:
automatically identifying, for at least one top contributing risk factor, a set of one or more adoption assets that most closely match a top contributing risk factor; and
providing information for the automatically identified set of one or more adoption assets in response to the request.

13. A system comprising:
one or more computers; and
a computer-readable medium coupled to the one or more computers having instructions stored thereon which, when executed by the one or more computers, cause the one or more computers to perform operations comprising:
identifying historical shelfware information for software products for different customers of a software provider;
using the historical shelfware information to train machine learning models, wherein each trained machine learning model is trained to generate a prediction that indicates a likelihood that a particular product for a particular customer will turn into shelfware;
receiving a request to generate a shelfware prediction for a first software product for a first customer of the software provider;
identifying a first trained machine learning model corresponding to the first software product and the first customer;
receiving a first shelfware risk prediction from the first trained machine learning model that indicates a likelihood that the first software product turns into shelfware for the first customer; and
providing the first shelfware risk prediction in response to the request.

14. The system of claim 13, wherein the historical shelfware information indicates whether software products purchased from the software provider turned into shelfware.

15. The system of claim 14, wherein a software product turns into shelfware if the software product is not used after being purchased.

16. The system of claim 13, wherein the first trained machine learning model is a random forest model.

17. A computer program product encoded on a non-transitory storage medium, the product comprising non-transitory, computer readable instructions for causing one or more processors to perform operations comprising:
identifying historical shelfware information for software products for different customers of a software provider;
using the historical shelfware information to train machine learning models, wherein each trained machine learning model is trained to generate a prediction that indicates a likelihood that a particular product for a particular customer will turn into shelfware;
receiving a request to generate a shelfware prediction for a first software product for a first customer of the software provider;
identifying a first trained machine learning model corresponding to the first software product and the first customer;
receiving a first shelfware risk prediction from the first trained machine learning model that indicates a likelihood that the first software product turns into shelfware for the first customer; and
providing the first shelfware risk prediction in response to the request.

18. The computer program product of claim 17, wherein the historical shelfware information indicates whether software products purchased from the software provider turned into shelfware.

19. The computer program product of claim 18, wherein a software product turns into shelfware if the software product is not used after being purchased.

20. The computer program product of claim 17, wherein the first trained machine learning model is a random forest model.
